(19) United States
(12) Patent Application Publication
(10) Pub. No.: US 2024/0326947 A1
(43) Pub. Date: Oct. 3, 2024

(54) HEADSET OF BICYCLE

(71) Applicant: TIEN HSIN INDUSTRIES CO., LTD., Taichung City (TW)

(72) Inventor: WEI-CHIH WEI, Taichung City (TW)

(21) Appl. No.: 18/235,353

(22) Filed: Aug. 18, 2023

(30) Foreign Application Priority Data
Mar. 27, 2023 (TW) 112111554

(51) Int. Cl. B62K 21/06; F16C 17/18; F16C 33/74

(52) U.S. Cl. CPC B62K 21/06; F16C 17/18; F16C 33/74; B62K 3/02; F16C 2326/26

(57) ABSTRACT

A headset of a bicycle includes a bearing base, a bearing cup, at least two sealing elements, damping fluid, and a bearing. The bearing base is adapted to be sleeved on a fork tube. The bearing cup is adapted to be abutted against an end, close to the fork tube, of a head tube, and a gap is formed between the bearing cup and the bearing base. The at least two sealing elements are disposed between the bearing cup and the bearing base, and the at least two sealing elements, the bearing cup and the bearing base seal the gap to form a damping section. The damping fluid is disposed in the damping section to provide damping force. The bearing is disposed between the bearing base and the bearing cup and is abutted against the bearing base and the bearing cup.

### FIELD OF THE INVENTION

The present disclosure relates to a bicycle part, and more particularly to a headset of a bicycle.

### BACKGROUND OF THE INVENTION

Cycling has the functions of both sightseeing and fitness, and the intensity of the exercise is adjustable with the choice of route or the type of bicycle. Therefore, in recent years, there are more and more people engaged in cycling. Generally, a conventional bicycle is provided with a headset between a head tube and a fork tube to act as an intermediary for the fork tube to rotate relative to the head tube. In addition, a bearing is disposed in the headset to reduce frictional force between the head tube and fork tube, so as to provide a smoother and more precise control feeling.

Generally, most headsets are designed to allow a rider to turn the fork tube flexibly, so the turning resistance may be minimized to make steering smooth and effortless. However, recently, applications of a bicycle have been gradually extended from solo cycling to carrying goods or parent-child riding. Therefore, under an increased load of the bicycle, if the headset is turned too smoothly, a handlebar is prone to swaying or oversteering due to low turning resistance when a user starts riding. Therefore, it is a major issue to appropriately improve turning resistance on the basis of appropriately smooth steering to ease steering in a case of starting without affecting the control feeling of the rider.

### SUMMARY OF THE INVENTION

The present disclosure provides a headset of a bicycle to have the advantages of being light in weight, easy to repair and maintain, and capable of providing smooth turning resistance.

A headset of a bicycle provided by the present disclosure includes a bearing base, a bearing cup, at least two sealing elements, damping fluid, and a bearing. The bearing base is adapted to be sleeved on a fork tube. The bearing cup is adapted to be abutted against an end, close to the fork tube, of a head tube, and a gap is formed between the bearing cup and the bearing base. The at least two sealing elements are disposed between the bearing cup and the bearing base, and the at least two sealing elements, the bearing cup and the bearing base seal the gap to form a damping section. The damping fluid is disposed in the damping section to provide damping force. The bearing is disposed between the bearing base and the bearing cup, and the bearing is abutted against the bearing base and the bearing cup.

According to one embodiment of the present disclosure, the bearing base may have a first tube portion and a first base ring portion connected to the first tube portion. The bearing cup may have a second tube portion and a second base ring portion connected to the second tube portion. The second tube portion is sleeved on the first tube portion, and the first base ring portion is surrounded by the second base ring portion. The gap is formed between the first tube portion and the second tube portion, and the gap has a first opening and a second opening opposite to the first opening. The second opening is located between the first base ring portion and the first opening. The sealing elements respectively seal the first opening and the second opening.

According to one embodiment of the present disclosure, the headset may further include an intermediate sealing element. The intermediate sealing element is disposed in the gap, and the intermediate sealing element seals the gap between the at least two sealing elements.

According to one embodiment of the present disclosure, the first tube portion has an outer circumferential surface. The second tube portion has an inner circumferential surface. The outer circumferential surface is opposite to the inner circumferential surface, at least one of the outer circumferential surface and the inner circumferential surface has a plurality of sealing grooves, and the sealing elements are disposed in the sealing grooves.

According to one embodiment of the present disclosure, the bearing may be abutted, for example, between the first base ring portion and the second base ring portion.

According to one embodiment of the present disclosure, the bearing base and the bearing cup are, for example, in a ring shape. The bearing base may have an inner ring surface, an outer ring surface, and a first surface. The outer ring surface is opposite to the inner ring surface, and the first surface is located between the inner ring surface and the outer ring surface. The bearing cup may have a second surface. The second surface is opposite to the first surface. The gap is formed between the first surface and the second surface, and the gap has a first opening and a second opening opposite to the first opening. The second opening is located between the inner ring surface and the first opening. The sealing elements respectively seal the first opening and the second opening.

According to one embodiment of the present disclosure, the first surface may have a first surface area increasing structure, and the second surface may have a second surface area increasing structure. A shape of the first surface area increasing structure is complementary to a shape of the second surface area increasing structure. The gap is formed between the first surface area increasing structure and the second surface area increasing structure.

According to one embodiment of the present disclosure, the first surface area increasing structure may have a plurality of first protruding ring portions, and a first concave ring portion is formed between every two adjacent ones of the first protruding ring portions. The second surface area increasing structure may have a plurality of second protruding ring portions, and a second concave ring portion is formed between every two adjacent ones of the second protruding ring portions. The second protruding ring portions are disposed corresponding to the first concave ring portions, and a shape of the second protruding ring portions is complementary to a shape of the first concave ring portions. The second concave ring portions are disposed corresponding to the first protruding ring portions, and a shape of the second concave ring portions is complementary to a shape of the first protruding ring portions.

According to one embodiment of the present disclosure, the bearing base has at least two sealing grooves. The at least two sealing grooves are located at two opposite sides of the first surface area increasing structure, and the sealing elements are disposed in the sealing grooves.

According to one embodiment of the present disclosure, the first surface may further have, for example, a first bearing positioning portion, and the first bearing positioning portion is located between the inner ring surface and the first surface area increasing structure. An inner ring surface of the bearing cup further has a second bearing positioning portion, and the second bearing positioning portion is corresponding to the first bearing positioning portion. The bearing is abutted between the first bearing positioning portion and the second bearing positioning portion.

According to one embodiment of the present disclosure, viscosity of the damping fluid is larger than 160 cSt.

According to one embodiment of the present disclosure, the viscosity of the damping fluid is between 200 cSt and 200000 cSt.

According to one embodiment of the present disclosure, the damping fluid includes, for example, grease or damping grease.

According to the headset of the present disclosure, the damping fluid is disposed in the gap between the bearing cup and the bearing base, and the sealing elements are further applied for the headset to seal the gap. Therefore, according to the headset of the present disclosure, the volume of the damping fluid may be reduced, and the damping fluid is further prevented from flowing out of the damping section by the sealing elements. In this way, the headset of the present disclosure is able to have the advantages of being light in weight and easy to repair and maintain, and with the damping fluid, the headset of the present disclosure is able to generate turning resistance when the headset is turned, so as to achieve smooth and gentle turning.

In order to make the above and other objectives, features and advantages of the present disclosure more clearly understood, embodiments are described below in detail in conjunction with the accompanying drawings.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a headset of a bicycle according to an embodiment of the present disclosure;

FIG. 2 is a schematic diagram of a case where the headset in FIG. 1 is disposed between a head tube and a fork tube;

FIG. 3 is a schematic diagram of a cross-sectional view of the headset in FIG. 2;

FIG. 4 is a schematic exploded diagram of the headset in FIG. 2;

FIG. 5 is a schematic diagram of a headset according to another embodiment of the present disclosure;

FIG. 6 is a schematic diagram of a cross-sectional view of a headset according to another embodiment of the present disclosure;

FIG. 7 is a schematic diagram of an enlarged view of the zone Z in FIG. 6; and

FIG. 8 is a schematic diagram of a cross-sectional view of a case where the bearing base and the bearing cup in FIG. 7 are separated.

### DETAILED DESCRIPTION OF PREFERRED EMBODIMENTS

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

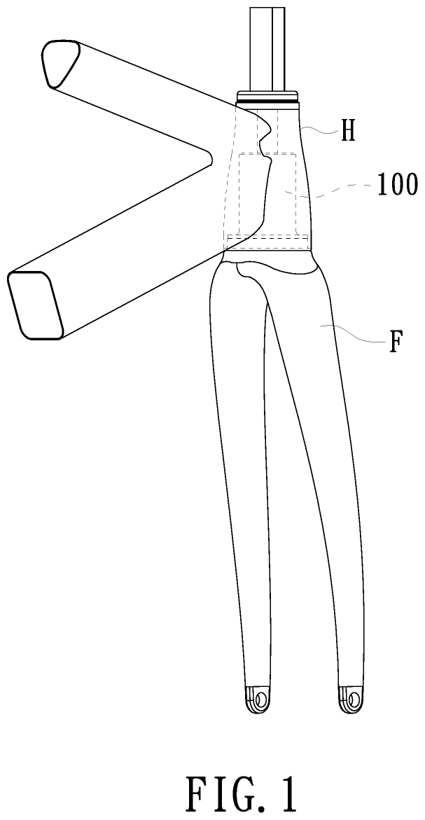

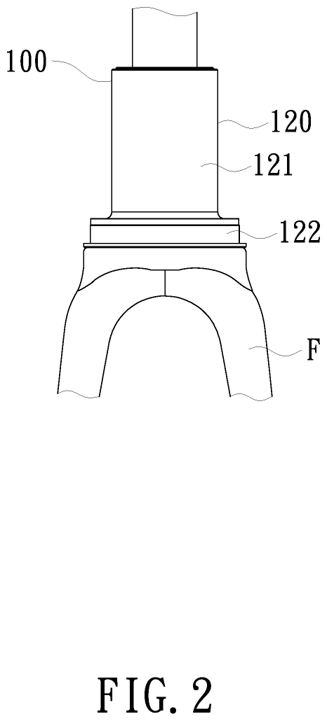

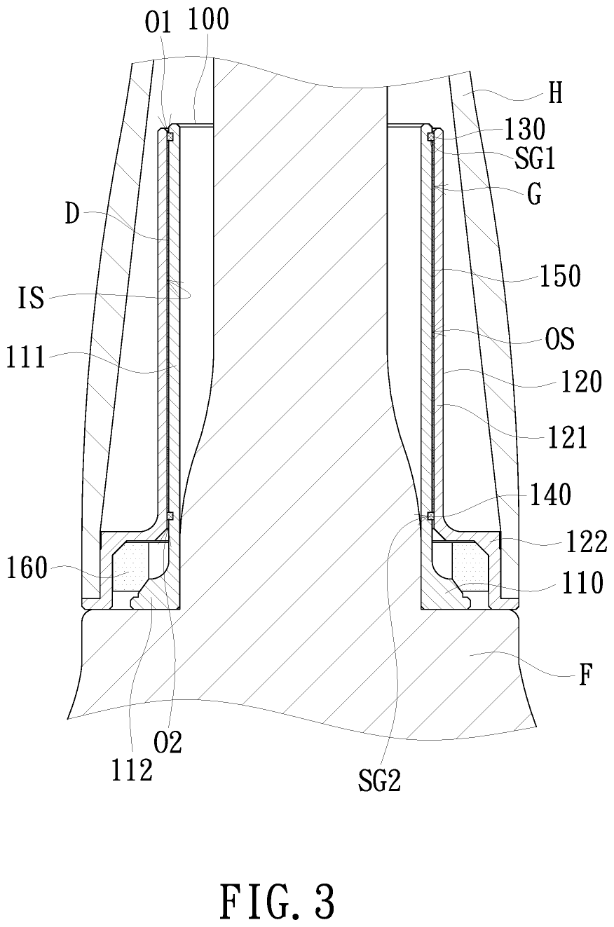

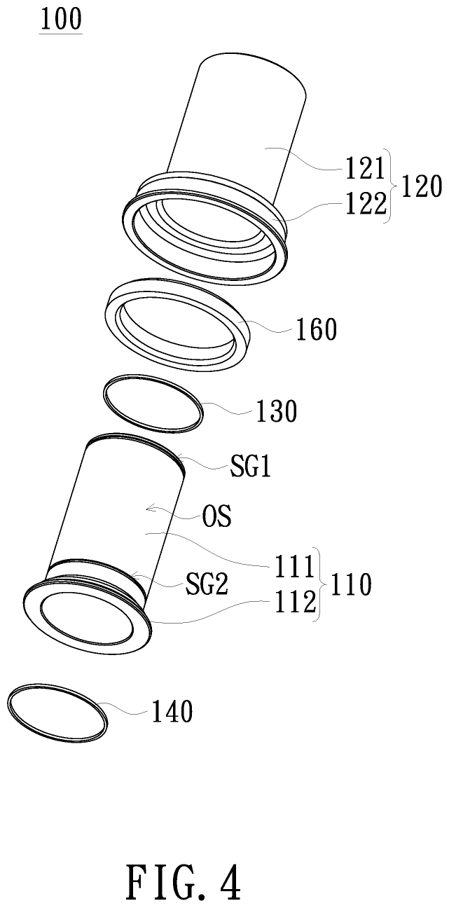

FIG. 1 is a schematic diagram of a headset of a bicycle according to an embodiment of the present disclosure. FIG. 2 is a schematic diagram of a case where the headset in FIG. 1 is disposed between a head tube and a fork tube. FIG. 3 is a schematic diagram of a cross-sectional view of the headset in FIG. 2. FIG. 4 is a schematic exploded diagram of the headset in FIG. 2.

Referring to FIG. 1 and FIG. 2 first, a headset 100 may be disposed between a head tube H and a fork tube F. Referring to FIG. 3 and FIG. 4, the headset 100 includes a bearing base 110, a bearing cup 120 (also numbered in FIG. 2), at least two sealing elements, damping fluid 150 (shown in FIG. 3), and a bearing 160. The number of the sealing elements 130 and 140 in this embodiment is exemplified by two, but the present disclosure is not limited thereto. In this embodiment, the bearing base 110 is adapted to be sleeved on the fork tube F. The bearing cup 120 is adapted to be abutted against an end, close to the fork tube F, of the head tube H, and a gap G is formed between the bearing cup 120 and the bearing base 110. The sealing elements 130 and 140 are disposed between the bearing cup 120 and the bearing base 110, and the sealing elements 130 and 140, the bearing cup 120 and the bearing base 110 seal the gap G to form a damping section D. The damping fluid 150 is disposed in the damping section D to provide damping force (that is, turning resistance). The bearing 160 is disposed between the bearing base 110 and the bearing cup 120, and the bearing 160 is abutted against the bearing base 110 and the bearing cup 120.

Continuing to refer to FIG. 3, the bearing base 110 is disposed, for example, on the fork tube F. Specifically, the bearing base 110 may have a first tube portion 111 and a first base ring portion 112 connected to the first tube portion 111. The first base ring portion 112 may be disposed on the fork tube F, and the first base ring portion 112 is fixed to the fork tube F due to a frictional force with the fork tube F, but the fixing manner is not limited by the present disclosure. The first base ring portion 112 may be fixed to the fork tube F by other means such as a fixing member or a collar based on different fixing manners and positions.

In this embodiment, the bearing cup 120 may be fixed to the head tube H. Further, the bearing cup 120 may have a second tube portion 121 and a second base ring portion 122 (also numbered in FIG. 2 and FIG. 4) connected to the second tube portion 121. The second base ring portion 122 may be disposed on the head tube H, and the second base ring portion 122 is abutted between the head tube H and the fork tube F, but the fixing manner is not limited by the present disclosure. In this embodiment, the bearing base 110 may be driven by the fork tube F to turn together, and the bearing cup 120 may be stationary relative to the bearing base 110 during turning of the bearing base 110. The head tube H may be stationary relative to the bearing base 110 when the bearing base 110 is slightly turned, thus allowing the fork tube F to be turned relative to the head tube H.

The bearing 160 is, for example, abutted between the first base ring portion 112 and the second base ring portion 122, but the position of the bearing 160 is not limited by the present disclosure. Specifically, the bearing 160 in this embodiment may be in a ring shape; however, in other embodiments, the shape of the bearing 160 may be changed based on the shape of the bearing base 110 and the shape of the bearing cup 120, and the specific shape of the bearing 160 is not limited by the present disclosure.

Referring to FIG. 3 and FIG. 4 again, in this embodiment, materials of the sealing elements 130 and 140 may include rubber or silicone, but the present disclosure is not limited thereto. In this embodiment, the second tube portion 121 of the bearing cup 120 is sleeved on the first tube portion 111 of the bearing base 110, and the first base ring portion 112 is surrounded by the second base ring portion 122. The gap G is formed between the first tube portion 111 and the second tube portion 121, and the gap G has a first opening O1 and a second opening O2 opposite to the first opening O1. The second opening O2 is located between the first base ring portion 112 and the first opening O1. The sealing elements 130 and 140 seal the first opening O1 and the second opening O2, respectively; in other words, the sealing element 130 may seal the first opening O1, and the sealing element 140 may seal the second opening O2. In this way, the sealing elements 130 and 140 may prevent the damping fluid 150 from leaking out of the first opening O1 or the second opening O2. In addition, the sealing elements 130 and 140 may also prevent water vapor or dust from penetrating into the damping section D through the first opening O1 and the second opening O2, thereby preventing the damping fluid 150 from being contaminated by water vapor or dust, and making the turning resistance provided by the headset 100 more easily maintained. Incidentally, in this embodiment, because the first opening O1 and the second opening O2 are in a ring shape, the sealing elements 130 and 140 may be in a ring shape. However, in other embodiments, the shape of the sealing elements 130 and 140 may be changed based on the shape of the first opening O1 and the shape of the second opening O2, which is not limited by the present disclosure.

The first tube portion 111 in this embodiment may have an outer circumferential surface OS, and the second tube portion 121 may have an inner circumferential surface IS (numbered in FIG. 3). The outer circumferential surface OS is opposite to the inner circumferential surface IS, and at least one of the outer circumferential surface OS and the inner circumferential surface IS has a plurality of sealing grooves, and this embodiment takes the outer circumferential surface OS having two sealing grooves SG1 and SG2 as an example. The sealing elements 130 and 140 are respectively disposed in the sealing grooves SG1 and SG2. Specifically, the sealing groove SG1 is close to, for example, the first opening O1, and the sealing groove SG2 may be close to the second opening O2. Furthermore, the sealing element 130 may be disposed in the sealing groove SG1 to seal the first opening O1; and similarly, the sealing element 140 may be disposed in the sealing groove SG2 to seal the second opening O2. As mentioned above, the sealing grooves SG1 and SG2 are not limited to being formed at the outer circumferential surface OS. For example, in one embodiment, the sealing grooves SG1 and SG2 may be formed at the inner circumferential surface IS of the second tube portion 121; and in another embodiment, the sealing grooves SG1 and SG2 may be formed at a position of the outer circumferential surface OS and another position of the inner circumferential surface IS opposite to the one of the outer circumferential surface OS. It is to be understood that, in other embodiments, the number of the sealing grooves may be changed based on the number of the sealing elements, which is thus not limited by the present disclosure.

Continuing to refer to FIG. 3, incidentally, the damping fluid 150 in this embodiment is located, for example, in the damping section D, and the sealing elements 130 and 140 are not covered by the damping fluid 150. However, in one embodiment, the damping fluid 150 may extend slightly into the sealing elements 130 and 140, and the sealing elements 130 and 140 may be covered by the damping fluid 150. In this embodiment, a desired effect of the present disclosure may be achieved as the viscosity of the damping fluid 150 is larger than 160 cSt, and a preferred range of the viscosity is between 200 cSt and 200000 cSt. In addition, the use environments and the types of bicycles may be different, for example, when riding on gravel, only a slight damping force is needed to prevent a handlebar from false turning. On the other hand, when a carrier bicycle with a large load is started by a rider, a large damping force is needed to prevent turning at the moment of starting the carrier bicycle. In this case, the most suitable range of the viscosity is between 200 cSt and 10000 cSt, which may provide sufficient turning resistance (that is, the aforementioned damping force) for the headset 100. In addition, the damping fluid 150 with higher viscosity may be disposed between the bearing base 110 and the bearing cup 120 more easily in a coated manner, so that the headset 100 is easier to assemble. For example, the sealing elements 130 and 140 may be first sleeved with the sealing grooves SG1 and SG2, and then the inner circumferential surface IS between the sealing elements 130 and 140 is coated with the damping fluid 150. After the inner circumferential surface IS between the sealing elements 130 and 140 is coated with the damping fluid 150, the bearing 160 is first disposed on the bearing base 110 in a sleeving manner, and then the bearing cup 120 is disposed on the bearing base 110 in a sleeving manner. It is to be understood that the aforementioned assembly process of the headset 100 of the bicycle is an example, which is not limited by the present disclosure. In this embodiment, the damping fluid 150 includes, for example, grease or damping grease, but the present disclosure is not limited thereto. Incidentally, in one embodiment, the outer circumferential surface OS and/or the inner circumferential surface IS may be roughened to increase a contact area between the damping fluid 150 and the outer circumferential surface OS and/or the inner circumferential surface IS, thereby improving the turning resistance between the bearing base 110 and the bearing cup 120.

Compared with the prior art, in the headset 100 of this embodiment, the damping fluid 150 is disposed in the gap G between the bearing cup 120 and the bearing base 110, and the sealing elements 130 and 140 are further applied for the headset 100 to seal the gap G. Therefore, according to the headset 100 of this embodiment, the volume of the damping fluid 150 may be reduced, and the damping fluid 150 is further prevented from flowing out of the damping section D by means of the sealing elements 130 and 140. In this way, the headset 100 of this embodiment is able to have the advantages of being light in weight and easy to repair and maintain.

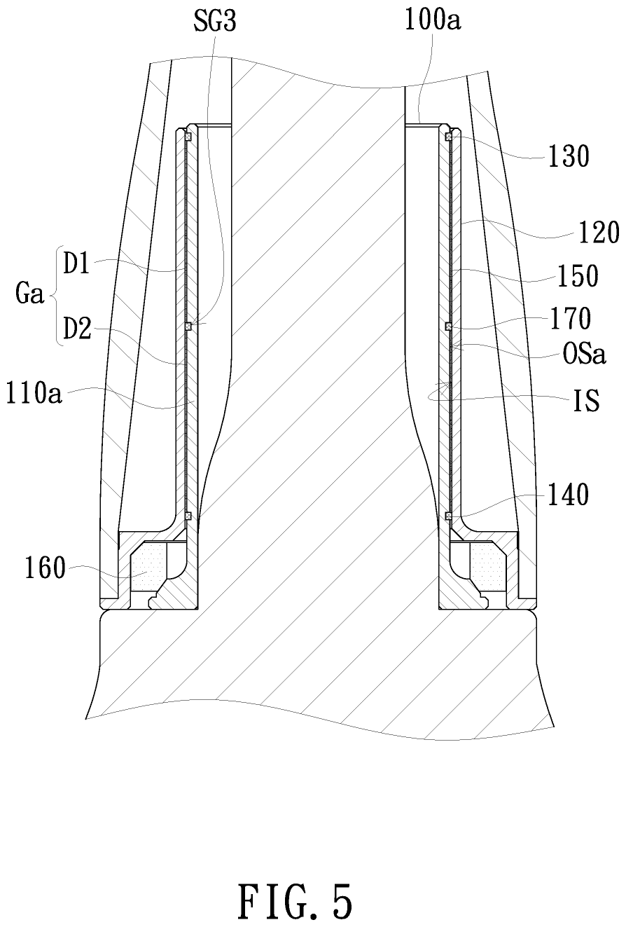

FIG. 5 is a schematic diagram of a headset according to another embodiment of the present disclosure. In this embodiment, the structure and advantages of the headset 100a are similar to those in the embodiment of FIG. 1, and the differences are described below. Referring to FIG. 5, the headset 100a may further include an intermediate sealing element 170. The intermediate sealing element 170 is disposed in a gap Ga, and the intermediate sealing element 170 seals the gap Ga between the sealing elements 130 and 140. Specifically, a space where the damping fluid 150 is disposed between an outer circumferential surface OSa and the inner circumferential surface IS may be reduced via the intermediate sealing element 170, so that the contact areas between the damping fluid 150 and the outer circumferential surface OSa as well as between the damping fluid 150 and the inner circumferential surface IS are reduced. Thus, the damping force provided by the damping fluid 150 may be further reduced via the intermediate sealing element 170, so that the turning resistance between the bearing base 110a and the bearing cup 120 is reduced. For example, a damping section D1 may be formed in the gap Ga between the intermediate sealing element 170 and the sealing element 130, and a damping section D2 may be formed in the gap Ga between the intermediate sealing element 170 and the sealing element 140; and the damping fluid 150 may be disposed in the damping sections D1 and D2. Similarly, the damping fluid 150 may be disposed on the outer circumferential surface OSa in a coated manner. Similarly, the outer circumferential surface OSa may have a sealing groove SG3 to allow the intermediate sealing element 170 to be disposed. In other embodiments, the sealing groove SG3 may be formed at the inner circumferential surface IS, or may be formed at a position of the outer circumferential surface OSa and another position of the inner circumferential surface IS opposite to the one of the outer circumferential surface OSa. It is to be understood that although the number of the intermediate sealing element 170 in this embodiment is one, the present disclosure is not limited thereto. For example, in one embodiment, there may be a plurality of intermediate sealing elements 170. The larger the number of the intermediate sealing elements 170 is, the less the space of the gap Ga allowing the damping fluid 150 to be disposed is, so that the turning resistance between the bearing base 110a and the bearing cup 120 can be further reduced. On the contrary, the smaller the number of the intermediate sealing elements 170 is, the more the space of the gap Ga allowing the damping fluid 150 to be disposed is, so that the turning resistance between the bearing base 110a and the bearing cup 120 can be further improved. The number of the intermediate sealing element 170 may be changed based on the needs for the above-mentioned turning resistance, which is thus not limited by the present disclosure.

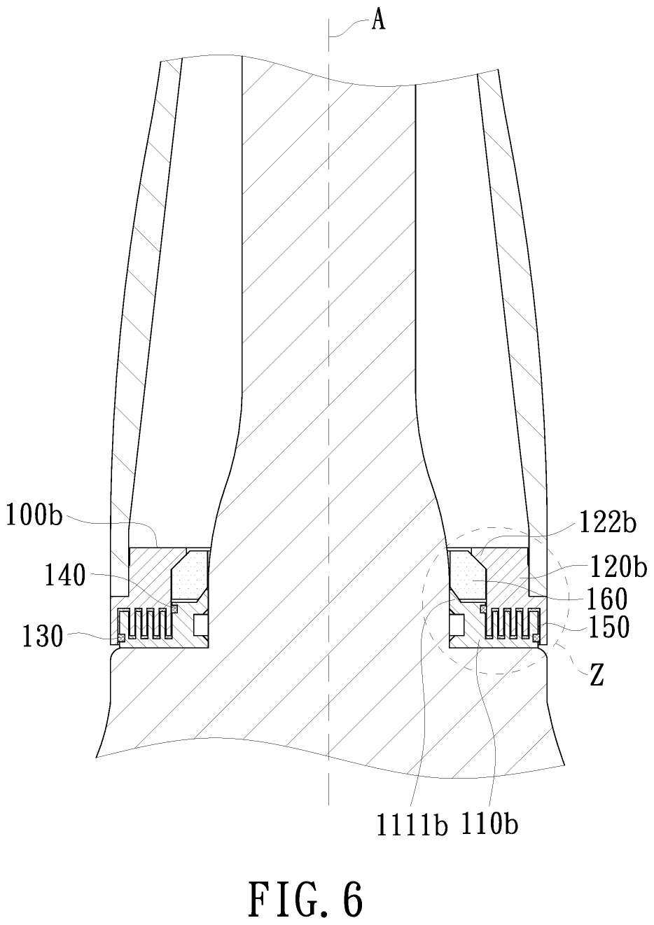

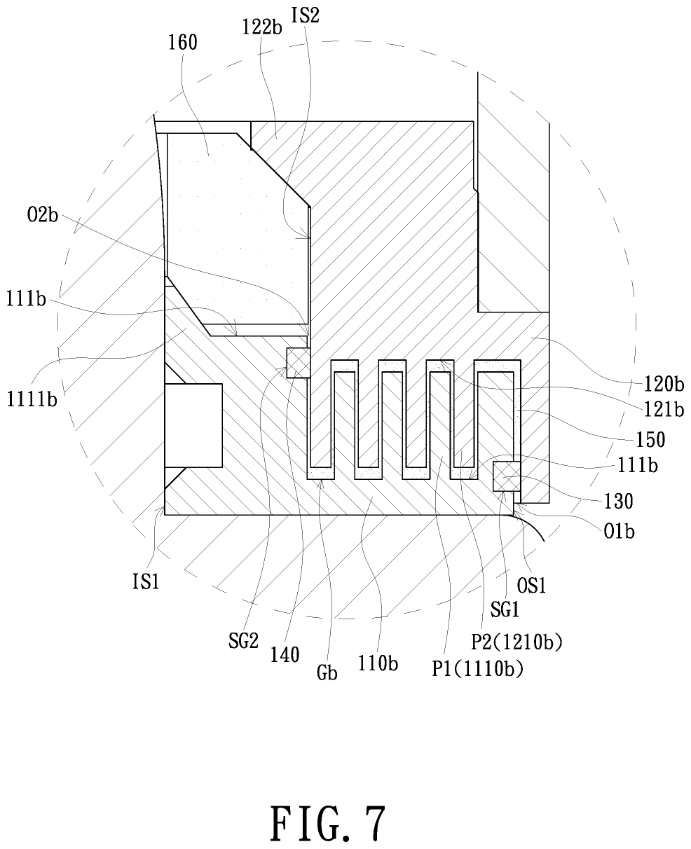

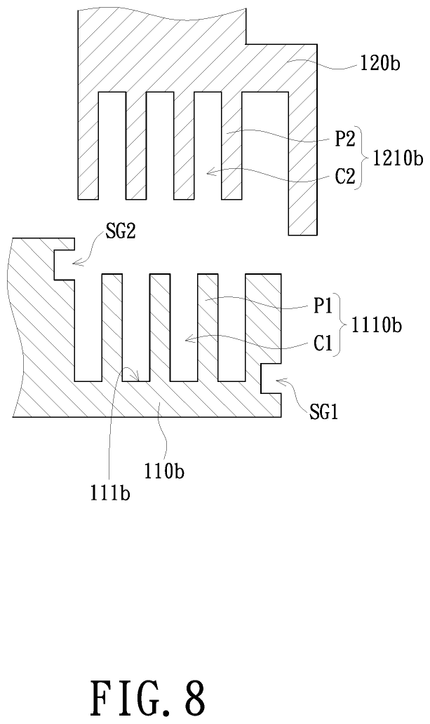

FIG. 6 is a schematic diagram of a cross-sectional view of a headset according to another embodiment of the present disclosure. FIG. 7 is a schematic diagram of an enlarged view of the zone Z in FIG. 6. FIG. 8 is a schematic diagram of a cross-sectional view of a case where the bearing base and the bearing cup in FIG. 7 are separated. In this embodiment, the structure and advantages of the headset 100b are similar to those in the embodiment of FIG. 1, and the differences are described below. Referring to FIG. 6 first, a bearing base 110b and a bearing cup 120b are, for example, in a ring shape. Referring to FIG. 7, the bearing base 110b may have an inner ring surface IS1, an outer ring surface OS1, and a first surface 111b. The outer ring surface OS1 is opposite to the inner ring surface IS1, and the first surface 111b is located between the inner ring surface IS1 and the outer ring surface OS1. The bearing cup 120b may have a second surface 121b. The second surface 121b is opposite to the first surface 111b. A gap Gb is formed between the first surface 111b and the second surface 121b, and the gap Gb has a first opening O1b and a second opening O2b opposite to the first opening O1b. The second opening O2b is located between the inner ring surface IS1 and the first opening O1b. The sealing elements 130 and 140 seal the first opening O1b and the second opening O2b, respectively. In short, since the shape of the bearing base 110b and the shape of the bearing cup 120b are different from those in the embodiment of FIG. 1, the damping fluid 150 is disposed in a different position from the embodiment of FIG. 1. Other features of the headset 100b will be further described below.

In this embodiment, the first surface 111b of the bearing base 110b may have a first surface area increasing structure 1110b, and the second surface 121b may have a second surface area increasing structure 1210b. A shape of the first surface area increasing structure 1110b is complementary to a shape of the second surface area increasing structure 1210b. The gap Gb is formed between the first surface area increasing structure 1110b and the second surface area increasing structure 1210b. Specifically, the contact area between the first surface 111b and the damping fluid 150 may be increased via the first surface area increasing structure 1110b, and the contact area between the second surface 121b and the damping fluid 150 may be increased via the second surface area increasing structure 1210b. Thus, the turning resistance between the bearing base 110b and the bearing cup 120b can be further improved.

Furthermore, referring to FIG. 7 and FIG. 8 together, the first surface area increasing structure 1110b may have a plurality of first protruding ring portions P1, and a first concave ring portion C1 (numbered in FIG. 8) is formed between every two adjacent ones of the first protruding ring portions P1. The second surface area increasing structure 1210b may have a plurality of second protruding ring portions P2, and a second concave ring portion C2 (numbered in FIG. 8) is formed between every two adjacent ones of the second protruding ring portions P2. The second protruding ring portions P2 are disposed corresponding to the first concave ring portions C1, and a shape of the second protruding ring portions P2 is complementary to a shape of the first concave ring portions C1. The second concave ring portions C2 are disposed corresponding to the first protruding ring portions P1, and a shape of the second concave ring portions C2 is complementary to a shape of the first protruding ring portions P1. In this embodiment, the bearing base 110b and the bearing cup 120b may be disposed substantially co-axially. The first protruding ring portions P1 and the first concave ring portions C1 surround, for example, an axis A (shown in FIG. 6) of the bearing base 110b; and similarly, the second protruding ring portions P2 and the second concave ring portions C2 surround, for example, an axis A (shown in FIG. 6) of the bearing cup 120b. In addition, the first protruding ring portions P1, the first concave ring portions C1, the second protruding ring portions P2 and the second concave ring portions C2 may be in the shape of a complete ring without segments, but in one embodiment, the first protruding ring portions P1, the first concave ring portions C1, the second protruding ring portions P2 and the second concave ring portions C2 may include a plurality of segments arranged into a ring. It is to be understood that the number of the first protruding ring portions P1 and the number of the second protruding ring portions P2 are not limited by the present disclosure. For example, in one embodiment, the number of the first protruding ring portions P1 and the number of the second protruding ring portions P2 may be increased, so that the contact areas between the first surface 111b and the damping fluid 150 as well as between the second surface 121b and the damping fluid 150 may be further increased, thereby further improving the turning resistance between the bearing base 110b and the bearing cup 120b. On the contrary, in another embodiment, the number of the first protruding ring portions P1 and the number of the second protruding ring portions P2 may be decreased, so that the contact areas between the first surface 111b and the damping fluid 150 as well as between the second surface 121b and the damping fluid 150 may be further decreased, thereby further reducing the turning resistance between the bearing base 110b and the bearing cup 120b.

Incidentally, in this embodiment, the bearing base 110b may have at least two sealing grooves, and this embodiment is exemplified by two sealing grooves SG1 and SG2. The sealing grooves SG1 and SG2 are located at two opposite sides of the first surface area increasing structure 1110b, and the sealing elements 130 and 140 are disposed in the sealing grooves SG1 and SG2, respectively. For example, the sealing groove SG1 may be located at a side, close to the outer ring surface OS1, of the first surface area increasing structure 1110b, and the sealing element 130 may be disposed therein. Similarly, in this embodiment, the sealing groove SG2 may be located at a side, close to the inner ring surface IS1, of the first surface area increasing structure 1110b, and the sealing element 140 may be disposed therein. It is to be understood that in one embodiment, the intermediate sealing element 170 in FIG. 5 may also be disposed between the sealing elements 130 and 140. Since the structure and advantages of the intermediate sealing element 170 have been described above, related descriptions are omitted herein. Similarly, in this embodiment, the sealing elements 130 and 140 may be respectively disposed in the sealing grooves SG1 and SG2 first, and then the first surface area increasing structure 1110b is coated with the damping fluid 150. After the first surface area increasing structure 1110b is coated with the damping fluid 150, the second surface area increasing structure 1210b is embedded into the first surface area increasing structure 1110b to complete assembling of the bearing base 110b and the bearing cup 120b. However, an assembling manner of the bearing base 110b and the bearing cup 120b is not limited by the present disclosure.

Referring to FIG. 6 and FIG. 7 together again, the first surface 1l1b of the bearing base 110b further has, for example, a first bearing positioning portion 1111b, and the first bearing positioning portion 1111b is located between the inner ring surface IS1 and the first surface area increasing structure 1110b. An inner ring surface IS2 (shown in FIG. 7) of the bearing cup 120b may further have a second bearing positioning portion 122b, and the second bearing positioning portion 122b is corresponding to the first bearing positioning portion 1111b. The bearing 160 is abutted between the first bearing positioning portion 1111b and the second bearing positioning portion 122b. Further, the first bearing positioning portion 1111b is protruded, for example, out of the first surface 111b, and one side of the bearing 160 may be abutted against the first bearing positioning portion 1111b. Similarly, the second bearing positioning portion 122b may be protruded out of the inner ring surface IS2, and another side of the bearing 160 may be abutted against the second bearing positioning portion 122b. In addition, in one embodiment, one side of the bearing 160 may be abutted against the first bearing positioning portion 1111b and a part of the first surface 111b, and the another side of the bearing 160 may be abutted against the second bearing positioning portion 122b and the inner ring surface IS2. Moreover, in this embodiment, a shape of the first bearing positioning portion 1111b and a shape of the second bearing positioning portion 122b may be changed to match a shape of the bearing 160, which are thus not limited by the present disclosure.

In summary, According to the headset of the present disclosure, the damping fluid is disposed in the gap between the bearing cup and the bearing base, and the sealing elements are further applied for the headset to seal the gap. Therefore, according to the headset of the present disclosure, the volume of the damping fluid may be reduced, and the damping fluid is further prevented from flowing out of the damping section by the sealing elements. In this way, the headset of the present disclosure is able to have the advantages of being light in weight and easy to repair and maintain, and with the damping fluid, the headset of the present disclosure is able to generate turning resistance when the headset is turned, so as to achieve smooth and gentle turning.

While the present disclosure has been described above in terms of the embodiments, the present disclosure is not limited thereto, and a person with ordinary skill in the art to which the present disclosure belongs may make some changes and modifications without departing from the spirit and scope of the present disclosure. Thus, the scope of protection of the present disclosure shall be subject to the scope of the appended patent application.

What is claimed is:

1. A headset of a bicycle, comprising:
a bearing base adapted to be sleeved on a fork tube;
a bearing cup adapted to be abutted against an end, close to the fork tube, of a head tube, and a gap being formed between the bearing cup and the bearing base;
at least two sealing elements disposed between the bearing cup and the bearing base, and the at least two sealing elements, the bearing cup and the bearing base sealing the gap to form a damping section;
a damping fluid disposed in the damping section to provide damping force; and
a bearing disposed between the bearing base and the bearing cup, and the bearing being abutted against the bearing base and the bearing cup.

2. The headset of the bicycle according to claim 1, wherein the bearing base has a first tube portion and a first base ring portion connected to the first tube portion, the bearing cup has a second tube portion and a second base ring portion connected to the second tube portion, the second tube portion is sleeved on the first tube portion, the first base ring portion is surrounded by the second base ring portion, the gap is formed between the first tube portion and the second tube portion, and the gap has a first opening and a second opening opposite to the first opening, the second opening is located between the first base ring portion and the first opening, and the sealing elements respectively seal the first opening and the second opening.

3. The headset of the bicycle according to claim 2, further comprising an intermediate sealing element, wherein the intermediate sealing element is disposed in the gap, and the intermediate sealing element seals the gap between the at least two sealing elements.

4. The headset of the bicycle according to claim 2, wherein the first tube portion has an outer circumferential surface, the second tube portion has an inner circumferential surface, the outer circumferential surface is opposite to the inner circumferential surface, and at least one of the outer circumferential surface and the inner circumferential surface has a plurality of sealing grooves, and the sealing elements are disposed in the sealing grooves.

5. The headset of the bicycle according to claim 2, wherein the bearing is disposed between and abutted against the first base ring portion and the second base ring portion.

6. The headset of the bicycle according to claim 1, wherein the bearing base and the bearing cup are in a ring shape, the bearing base has an inner ring surface, an outer ring surface and a first surface, the outer ring surface is opposite to the inner ring surface, the first surface is located between the inner ring surface and the outer ring surface, the bearing cup has a second surface, the second surface is opposite to the first surface, the gap is formed between the first surface and the second surface, and the gap has a first opening and a second opening opposite to the first opening, the second opening is located between the inner ring surface and the first opening, the at least two sealing elements respectively seal the first opening and the second opening.

7. The headset of the bicycle according to claim 6, wherein the first surface has a first surface area increasing structure, the second surface has a second surface area increasing structure, a shape of the first surface area increasing structure is complementary to a shape of the second surface area increasing structure, the gap is formed between the first surface area increasing structure and the second surface area increasing structure.

8. The headset of the bicycle according to claim 7, wherein the first surface area increasing structure has a plurality of first protruding ring portions, and a first concave ring portion is formed between every two adjacent ones of the first protruding ring portions, the second surface area increasing structure has a plurality of second protruding ring portions, and a second concave ring portion is formed between every two adjacent ones of the second protruding ring portions, the second protruding ring portions are disposed corresponding to the first concave ring portions, and a shape of the second protruding ring portions is complementary to a shape of the first concave ring portions, the second concave ring portions are disposed corresponding to the first protruding ring portions, and a shape of the second concave ring portions is complementary to a shape of the first protruding ring portions.

9. The headset of the bicycle according to claim 7, wherein the bearing base has at least two sealing grooves, the at least two sealing grooves are located at two opposite sides of the first surface area increasing structure, and the sealing elements are disposed in the sealing grooves.

10. The headset of the bicycle according to claim 7, wherein the first surface further has a first bearing positioning portion, the first bearing positioning portion is located between the inner ring surface and the first surface area increasing structure, an inner ring surface of the bearing cup further has a second bearing positioning portion, the second bearing positioning portion is corresponding to the first bearing positioning portion, and the bearing is abutted between the first bearing positioning portion and the second bearing positioning portion.

11. The headset of the bicycle according to claim 1, wherein viscosity of the damping fluid is larger than 160 cSt.

12. The headset of the bicycle according to claim 11, wherein the viscosity of the damping fluid is between 200 cSt and 200000 cSt.

13. The headset of the bicycle according to claim 11, wherein the damping fluid comprises grease or damping grease.
